(19) United States
(12) Patent Application Publication
(10) Pub. No.: US 2010/0321959 A1
(43) Pub. Date: Dec. 23, 2010

(54) CONVERTER

(75) Inventor: Shinichiro Matsumoto, Numazu-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/818,065

(22) Filed: Jun. 17, 2010

(30) Foreign Application Priority Data
Jun. 23, 2009 (JP) 2009-149067

(51) Int. Cl. H02M 3/335

(52) U.S. Cl. 363/21.02

(57) ABSTRACT

A converter includes a control unit configured to turn ON, when an output voltage is set to a low voltage, a switching element according to a pulse voltage induced in a first auxiliary winding of a transformer. The control unit operates based on a direct current voltage output by rectifying and smoothing a pulse voltage induced in a second auxiliary winding of the transformer.

### BACKGROUND OF THE INVENTION

1. Field of the Invention

The present invention relates to a converter for converting a voltage.

2. Description of the Related Art

As a voltage converter in a power source of an electronic apparatus, there is known a quasi-resonant converter like that illustrated in FIG. 6. FIG. 6 illustrates a circuitry when the quasi-resonant converter is applied to a switching power source. Hereinafter, referring to FIGS. 6 and 7, a circuit operation is described.

When a switch SW1 is turned ON, a commercial alternating voltage Vac is rectified by a diode bridge DA1, which includes diodes D101, D102, D103, and D104, and smoothed by a primary electrolytic capacitor C1 to become a roughly constant voltage Vh. Simultaneously, a voltage is supplied to a control module CNT1 via an activation resistor R4. The control module CNT1 turns ON a field-effect transistor FET1. Then, a drain current Id flows to the field-effect transistor FET1 via a primary winding Np of a transformer T1 (time t0 in FIG. 7). supply voltage Vcc supplied to the control module CNT1 never exceeds the rated voltage.

The present exemplary embodiment enables, even when the voltage of the commercial alternating power source increases, prevention of the power supply voltage Vcc supplied to the control module CNT1 from exceeding the rated voltage.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2009-149067 filed Jun. 23, 2009, which is hereby incorporated by reference herein in its entirety.

The drain current Id is converted into a voltage Vis by a current detection resistor R3 to be supplied to the control module CNT1. The control module CNT1 turns OFF the field-effect transistor FET1 when the voltage Vis reaches a prescribed value (time t1).

After the field-effect transistor FET1 has been tuned OFF, the drain current Id instantly becomes zero. A primary winding current Ip that has flowed through the field-effect transistor FET1 flows into a primary resonant capacitor C2 to charge the primary resonant capacitor C2. Then, a voltage Vds between a drain and a source of the field-effect transistor FET1 starts to increase. Immediately after the field-effect transistor FET1 has been turned OFF, the voltage Vds greatly jumps up (time t2). A waveform of this increased voltage is a result from an LC resonant operation (resonance phenomenon) between inductance (leakage inductance) Lpr of the primary winding Np and capacitance Cr1 of the primary resonant capacitor C2. The voltage Vds thereafter becomes a roughly constant voltage Vh+Vc1 (time t2 to time t3).

The transformer T1 has, in addition to the primary winding Np, a secondary winding Ns and an auxiliary winding Nn wound thereon. Winding directions of the secondary winding Ns and the auxiliary winding Nn are different from that of the primary winding Np (flyback coupling). After the field-effect transistor FET1 has been turned OFF (time t2 to time t3), positive pulse voltages are induced in the secondary winding Ns and the auxiliary winding Nn. The pulse voltage induced in the secondary winding Ns is rectified and smoothed by a secondary rectifying diode D3 and a secondary smoothing capacitor C4 to become a roughly constant output voltage Vout-h. In this case, the voltage Vc1 is generally represented by the following expression (1) using the output voltage Vout-h, where Vfd3 denotes a forward voltage of the secondary rectifying diode D3:

$${V}_{c 1} ≅ ( {V}_{out - h} + {V}_{fd 3} ) \cdot \frac{{N}_{p}}{{N}_{s}} \qquad ( 1 )$$

The positive pulse voltage induced in the auxiliary winding Nn is generally represented by the following expression (2) using the output voltage Vout-h:

$${V}_{nnh} ≅ ( {V}_{out - h} + {V}_{fd 3} ) \cdot \frac{{N}_{n}}{{N}_{s}} \qquad ( 2 )$$

The positive pulse voltage Vnnh is rectified and smoothed by a diode D2 and a capacitor C3, and supplied as a power supply voltage Vcc to the control module CNT1. Thereafter, the control module CNT1 continues its operation based on the power supply voltage Vcc. In this case, the power supply voltage Vcc is generally represented by the following expression (3), where Vfd2 denotes a forward voltage of the diode D2:

$${V}_{cc} ≅ {V}_{nnh} - {V}_{fd 2} ≅ ( {V}_{out - h} + {V}_{fd 3} ) \cdot \frac{{N}_{n}}{{N}_{s}} - {V}_{fd 2} \qquad ( 3 )$$

A current If flowing through the secondary winding Ns is linearly reduced to become zero before long (time t3). Then, the voltage Vds starts to slowly decrease (time t3 to time t4). A waveform of this decreased voltage is a result from an LC resonance phenomenon between the inductance Lp and the capacitance Cr1, and a frequency f0, a period T0, and initial amplitude A0 thereof are generally represented by the following expressions (4) to (6). Thereafter, unless the field-effect transistor FET1 is turned ON again, as indicated by a broken line of the voltage Vds in the graph of FIG. 7, the LC resonance phenomenon continues at the frequency f0:

$${f}_{0} ≅ \frac{1}{2 π \sqrt{{L}_{p} \cdot {C}_{r 1}}} \qquad ( 4 )$$

T₀≅2π\sqrt{Lₚ·Cᵣ₁} (5)

A₀≅V_{c1} (6)

The voltage Vds is similar in shape to an anode voltage Vnn of the diode D2. The anode voltage Vnn has been supplied to the control module CNT1. The control module CNT1 is set to detect time (t4) when the anode voltage Vnn becomes zero, and to turn ON the field-effect transistor FET1 after a passage of a prescribed period of time from time t4. It is a feature of the quasi-resonant converter that based on this arrangement, a switching loss or radiation noise is reduced by turning ON the field-effect transistor FET1 at the time when the voltage Vds becomes lowest. Each of periods of time Δt from time t3 to time t4 and from time t4 to time t5 is ¼ of the LC resonance period T0, which is a known value generally represented by the following expression (7):

$$Δ t ≅ \frac{{T}_{0}}{4} ≅ \frac{π \sqrt{{L}_{p} \cdot {C}_{r 1}}}{2} \qquad ( 7 )$$

Thus, by turning ON the field-effect transistor FET1 after the passage of the period of time Δt from time t4, the field-effect transistor FET1 can be turned ON at a lowest point of the LC resonant voltage (time t5). In FIG. 7, the field-effect transistor FET1 is turned ON in a state where the voltage Vds decreases below zero and a body diode D1 of the field-effect transistor FET1 becomes conductive. Switching at a point of time when the voltage Vds is roughly zero is generally referred to as zero volt switching (ZVS). Performing zero volt switching enables great reduction of a switching loss or radiation noise at the time of turning-ON.

When the field-effect transistor FET1 is turned ON (time t5 and after), a drain current Id starts to flow again to the field-effect transistor FET1 via the primary winding Np of the transformer T1. In this case, negative pulse voltages are induced in the secondary winding Ns and the auxiliary winding Nn. The negative pulse voltage Vnn1 induced in the auxiliary winding Nn is generally represented by the following expression (8) using a voltage Vh:

$${V}_{nn 1} ≅ {V}_{h} \cdot \frac{{N}_{n}}{{N}_{p}} \qquad ( 8 )$$

Thereafter, the operation at time t0 to time t5 is repeated. The operation of the quasi-resonant converter has been described. The operation of the quasi-resonant converter at the switching power source is discussed in, for example, Japanese Patent Application Laid-Open No. 2002-315330.

In recent years, there has been a conspicuous rise in demand for reducing power consumption of an electronic apparatus. A power source that includes the quasi-resonant converter is expected to reduce power consumption. In order to reduce power consumption, a normal mode when the electronic apparatus is operated and a power saving mode when the electronic apparatus is on standby are provided. Power during standing-by is reduced by decreasing an output voltage of the quasi-resonant converter.

FIG. 8 illustrates an example of the quasi-resonant converter for reducing power during standing-by decreasing the output voltage. In FIG. 8, an output variable circuit that includes resistors Ra, Rb, Rc, and R8 and a field-effect transistor FET2 is added to the quasi-resonant converter illustrated in FIG. 6. A power saving signal /PSAVE is supplied to the output variable circuit from a control element CPU1 of the electronic apparatus. The control element CPU1 changes the electronic apparatus from the normal mode to the power saving mode based on the /PSAVE signal.

The control element CPU 1 sets the /PSAVE signal to an H level in order to set the electronic apparatus to the normal mode, and to an L level in order to set the electronic apparatus to the power saving mode. The /PSAVE signal has been supplied to the field-effect transistor FET2. In the normal mode, more specifically, when the /PSAVE signal is at the H level, the field-effect transistor FET2 is turned ON to connect the resistor Rb and the resistor Rc in parallel. A voltage resulting from dividing the output voltage by the resistor Ra and the parallel resistance (Rb//Rc) is supplied to a ref terminal of a shunt regulator IC1. Thus, an output voltage Vout-h of the normal mode is generally represented by the following expression (9), where Vref denotes a reference voltage of the shunt regulator:

$${V}_{out - h} ≅ \frac{{R}_{a} + ( {R}_{b} // {R}_{c} )}{( {R}_{b} // {R}_{c} )} \cdot {V}_{ref} \qquad ( 9 )$$

The parallel resistance (Rb//Rc) is a parallel resistance value of the resistors Rb and Rc, which is generally represented by the following expression (10):

$${R}_{b} // {R}_{c} = \frac{{R}_{b} \cdot {R}_{c}}{{R}_{b} + {R}_{c}} \qquad ( 10 )$$

In the power saving mode, more specifically, when the /PSAVE signal is at the L level, the field-effect transistor FET2 is turned OFF to separate the resistor Rc. The voltage supplied to the ref terminal of the shunt regulator IC1 becomes a voltage resulting from dividing the output voltage by the resistors Ra and Rb. Thus, an output voltage Vout-l of the power saving mode is generally represented by the following expression (11):

$${V}_{out - 1} ≅ \frac{{R}_{a} + {R}_{b}}{{R}_{b}} \cdot {V}_{ref} \qquad ( 11 )$$

As a result, the output voltage Vout-l of the power saving mode is lower than the output voltage Vout-h of the normal mode.

FIGS. 9A and 9B illustrate operation waveforms of the quasi-resonant converter in the normal mode and the power saving mode, respectively. The operation in the normal mode is similar to that described above referring to FIG. 7. In the power saving mode, when the output voltage decreases from Vout-h to Vout-l, the voltage Vc1 decreases as generally represented by the following expression (12):

$${V}_{c 1} ≅ ( {V}_{out - 1} + {V}_{fd 3} ) \cdot \frac{{N}_{p}}{{N}_{s}} \qquad ( 12 )$$

When the field-effect transistor FET1 is OFF, the positive pulse voltage Vnnh induced in the auxiliary winding Nn decreases as generally represented by the following expression (13):

$${V}_{nnh} ≅ ( {V}_{out - 1} + {V}_{fd 3} ) \cdot \frac{{N}_{n}}{{N}_{s}} \qquad ( 13 )$$

The positive pulse voltage Vnnh decreases, and hence the power supply voltage Vcc of the control module CNT1 decreases as generally represented by the following expression (14):

$${V}_{α} ≅ {V}_{nnh} - {V}_{fd 2} ≅ ( {V}_{out - 1} + {V}_{fd 3} ) \cdot \frac{{N}_{n}}{{N}_{s}} - {V}_{fd 2} \qquad ( 14 )$$

As described above, in the power saving mode, the output voltage is reduced, and hence the power supply voltage Vcc of the control module CNT1 decreases. In order to stably operate the control module CNT1, the power supply voltage Vcc is to be maintained at least a fixed value, placing a limit on a reduction amount of the output voltage . As a result, power consumption in the power saving mode cannot be sufficiently reduced.

### SUMMARY OF THE INVENTION

According to an aspect of the present invention, a converter includes a switching element configured to switch a voltage supplied via a primary winding of a transformer, a control unit configured to control timing so as to turn ON the switching element based on a resonant voltage supplied to the switching element by a resonant operation between inductance of the primary winding and capacitance between a drain and a source of the switching element, and a setting unit configured to set an output voltage. When the output voltage is set to a low voltage, the control unit turns ON the switching element according to a first pulse voltage induced in a first auxiliary winding different in winding direction from the primary winding, and operates based on a second direct current voltage output by rectifying and smoothing a second pulse voltage induced in a second auxiliary winding similar in winding direction to the primary winding.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a circuitry of a quasi-resonant converter according to a first exemplary embodiment of the present invention.

FIG. 2 illustrates voltage waveforms when the quasi-resonant converter is in a normal mode according to the first exemplary embodiment.

FIG. 3 illustrates voltage waveforms when the quasi-resonant converter is in a power saving mode according to the first exemplary embodiment.

FIG. 4 illustrates a circuitry of a quasi-resonant converter according to a second exemplary embodiment of the present invention.

FIG. 5 illustrates a circuitry of a quasi-resonant converter according to a third exemplary embodiment of the present invention.

FIG. 6 illustrates a circuitry of a conventional quasi-resonant converter.

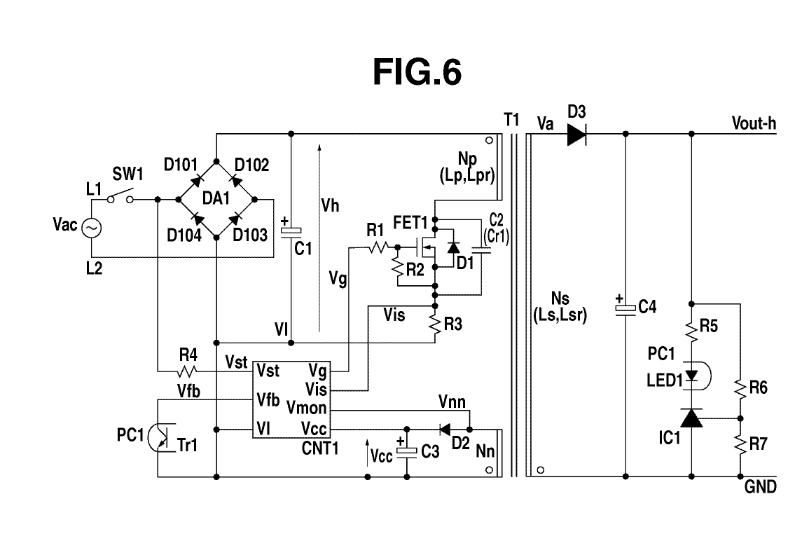

FIG. 7 illustrates operation waveforms during an operation of the conventional quasi-resonant converter.

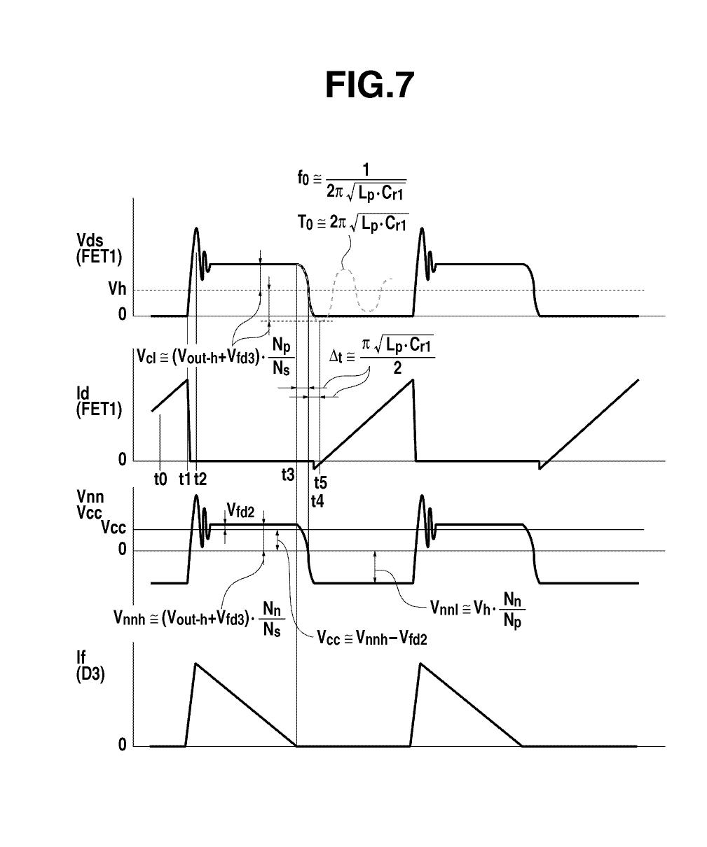

FIG. 8 illustrates a circuitry of a conventional quasi-resonant converter.

FIGS. 9A and 9B illustrate voltage waveforms when the conventional quasi-resonant converter is in a normal mode and in a power saving mode, respectively.

### DESCRIPTION OF THE EMBODIMENTS

Various exemplary embodiments, features, and aspects of the invention will be described in detail below with reference to the drawings.

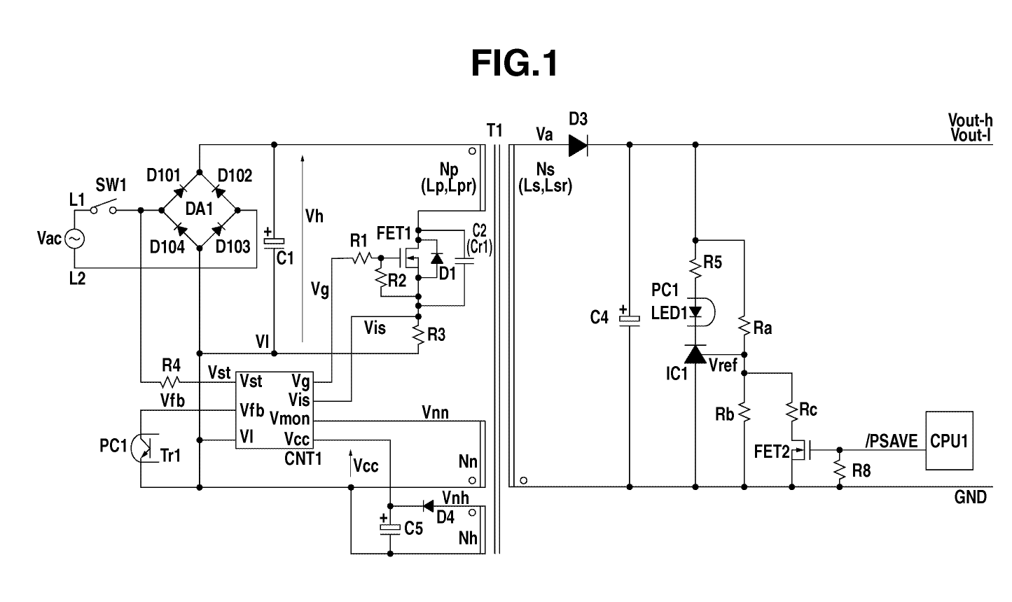

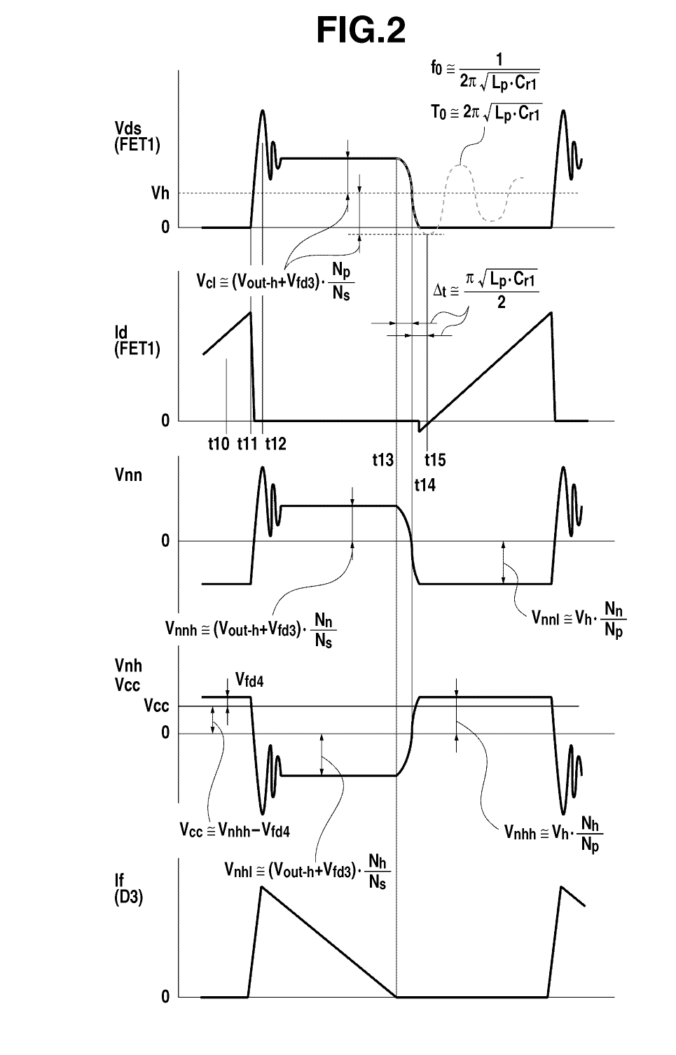

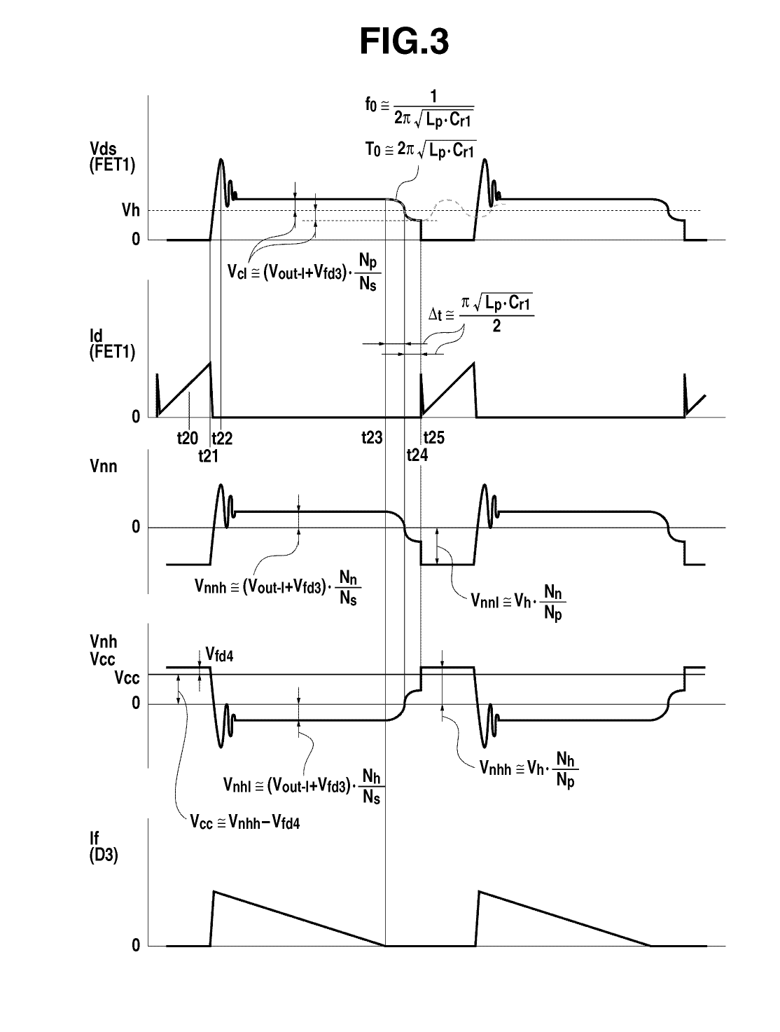

FIG. 1 illustrates a circuitry of a quasi-resonant converter according to a first exemplary embodiment of the present invention. FIG. 2 illustrates voltage waveforms when the quasi-resonant converter is in a normal mode. FIG. 3 illustrates an operation when the quasi-resonant converter is in a power saving mode.

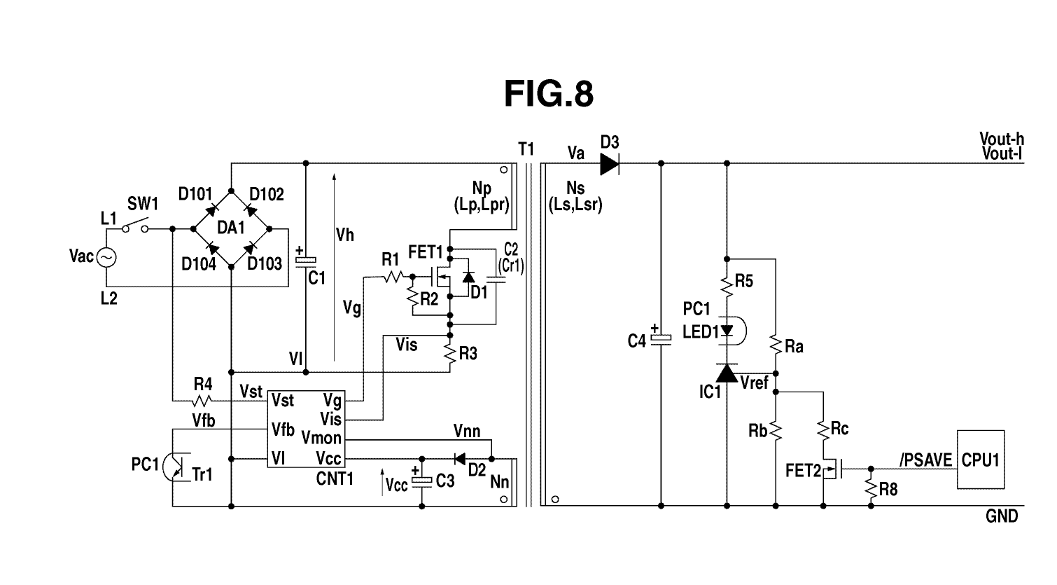

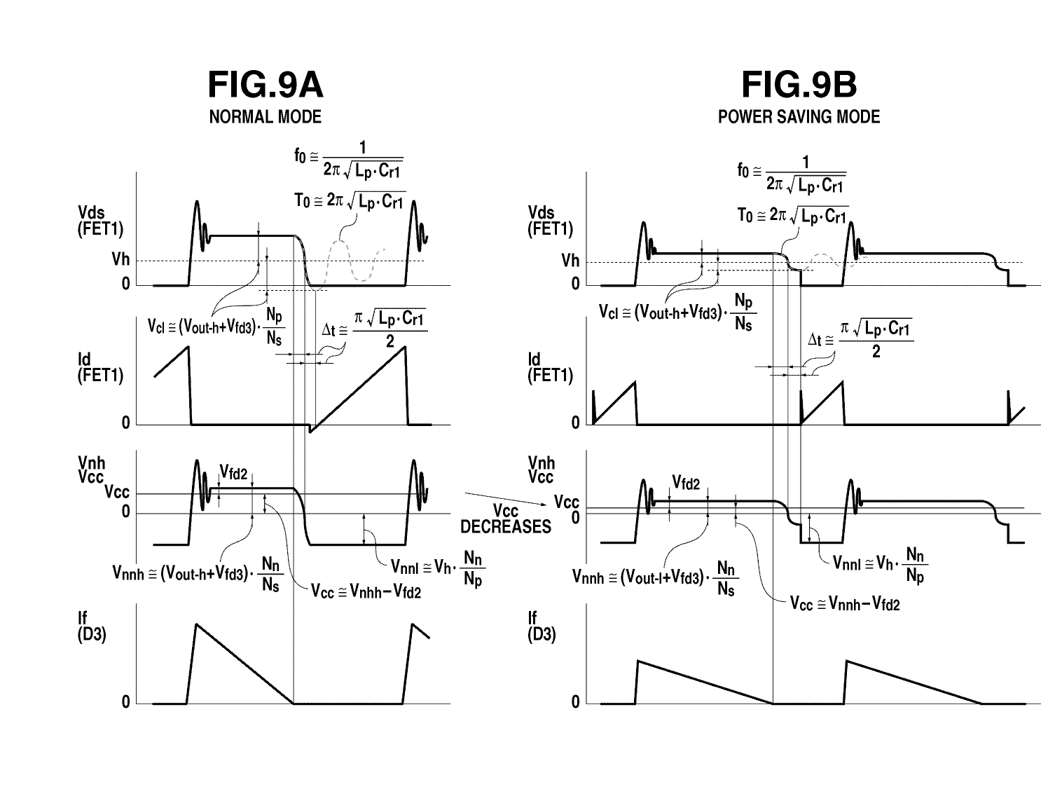

In the present exemplary embodiment, the quasi-resonant converter includes, in addition to components of a quasi-resonant converter illustrated in FIG. 8 and FIGS. 9A and 9B, a rectifying and smoothing circuit which includes a second auxiliary winding Nh of a transformer T1, a diode D4, and a capacitor C5 (configuration referred to as forward coupling). A direct current voltage generated by the second auxiliary winding Nh, the diode D4, and the capacitor C5 is set as a power supply voltage Vcc of a control module CNT1 which performs ON/OFF timing control for a field-effect transistor FET1 serving as a switching element. AN LC resonant operation (resonance phenomenon) between inductance of a primary winding Np of the quasi-resonant converter and capacitance of a primary resonant capacitor C2 is common, and thus a similar portion is denoted by similar reference numeral.

Hereinafter, referring to FIGS. 1 to 3, an operation of the present exemplary embodiment is described.

The quasi-resonant converter illustrated in FIG. 1 includes an output voltage setting circuit which includes resistors Ra, Rb, Rc, and R8 and a field-effect transistor FET2. A power saving signal /PSAVE has been supplied to the output voltage setting circuit from a control element CPU1 of an electronic apparatus (apparatus, hereinafter). The control element CPU 1 changes the apparatus from a normal mode to a power saving mode based on the /PSAVE signal.

The control element CPU 1 sets the /PSAVE signal to an H level in order to set the apparatus in the normal mode, and to an L level in order to set the apparatus in the power saving mode. The /PSAVE signal has been supplied to the field-effect transistor FET2. In the normal mode, more specifically, when the /PSAVE signal is at the H level, the field-effect transistor FET2 is turned ON to connect the resistor Rb and the resistor Rc in parallel. A voltage resulting from dividing an output voltage by the resistor Ra and the parallel resistance (Rb//Rc) is accordingly supplied to a ref terminal of a shunt regulator IC1. Thus, an output voltage Vout-h in the normal mode is generally represented by the following expression (15), where Vref denotes a reference voltage of the shunt regulator:

$${V}_{out - h} ≅ \frac{{R}_{a} + ( {R}_{b} // {R}_{c} )}{( {R}_{b} // {R}_{c} )} \cdot {V}_{ref} \qquad ( 15 )$$

The parallel resistance (Rb//Rc) is a parallel resistance value of the resistors Rb and Rc, and generally represented by the following expression (16):

$${R}_{b} // {R}_{c} = \frac{{R}_{b} \cdot {R}_{c}}{{R}_{b} + {R}_{c}} \qquad ( 16 )$$

In the power saving mode, more specifically, when the /PSAVE signal is at the L level, the field-effect transistor FET2 is turned OFF to separate the resistor Rc. A voltage supplied to the ref terminal of the shunt regulator IC1 accordingly becomes a voltage resulting from dividing the output voltage by the resistors Ra and Rb. Thus, an output voltage Vout-l of the power saving mode is generally represented by the following expression (17):

$${V}_{out - 1} ≅ \frac{{R}_{a} + {R}_{b}}{{R}_{b}} \cdot {V}_{ref} \qquad ( 17 )$$

Thus, the output voltage Vout-l of the power saving mode is lower than the output voltage Vout-h of the normal mode.

FIG. 2 illustrates operation waveforms of the quasi-resonant converter in the normal mode. While the field-effect transistor FET1 is OFF, a voltage Vds between the drain and the source of the field-effect transistor FET1 becomes a roughly constant voltage Vh+Vc1 (voltage during a period of time t12 to time t13). The transformer T1 has, in addition to the primary winding Np, a secondary winding Ns, a first auxiliary winding Nn, and a second auxiliary winding Nh wound thereon. The secondary winding Ns and the first auxiliary winding Nn are different in winding direction from the primary winding Np (configuration referred to as flyback coupling). Thus, after the field-effect transistor FET1 is turned OFF (period of time t12 to time t13), positive pulse voltages are induced in the secondary winding Ns and the first auxiliary winding Nn. On the other hand, the second auxiliary winding Nh is similar in winding direction to the primary winding Np (configuration referred to as forward coupling). Thus, after the field-effect transistor FET1 is turned OFF (period of time t12 to time t13), a negative pulse voltage is induced in the second auxiliary winding Nh. The pulse voltage induced in the secondary winding Ns is rectified and smoothed by a secondary rectifying diode D3 and a secondary smoothing capacitor C4 to become a roughly constant output voltage Vout-h. In this case, the voltage Vc1 is generally represented by the following expression (18) using the output voltage Vout-h, where Vfd3 denotes a forward voltage of the secondary rectifying diode D3:

$${V}_{c 1} ≅ ( {V}_{out - h} + {V}_{fd 3} ) \cdot \frac{{N}_{p}}{{N}_{s}} \qquad ( 18 )$$

The positive pulse voltage Vnnh induced in the first auxiliary winding Nn is generally represented by the following expression (19) using the output voltage Vout-h:

$${V}_{nnh} ≅ ( {V}_{out - h} + {V}_{fd 3} ) \cdot \frac{{N}_{n}}{{N}_{s}} \qquad ( 19 )$$

The negative pulse voltage Vnh1 induced in the second auxiliary winding Nh is generally represented by the following expression (20) using the output voltage Vout-h:

$${V}_{nh 1} ≅ ( {V}_{out - h} + {V}_{fd 3} ) \cdot \frac{{N}_{h}}{{N}_{s}} \qquad ( 20 )$$

A current If flowing through the secondary winding Ns linearly decreases to become zero (time t13). Then, the voltage Vds starts to slowly decrease (period of time t13 to time t14). A waveform of this decreased voltage is an LC resonance phenomenon between inductance Lp and capacitance Cr1, and a frequency f0, a period T0, and initial amplitude A0 thereof are generally represented by the following expressions (21), (22), and (23). Thereafter, unless the field-effect transistor FET1 is turned ON again, as indicated by a broken line of a voltage Vds illustrated in FIG. 2, the LC resonance phenomenon continues at the frequency f0.

$${f}_{0} ≅ \frac{1}{2 π \sqrt{{L}_{p} \cdot {C}_{r 1}}} \qquad ( 21 )$$

T₀≅2π\sqrt{Lₚ·Cᵣ₁} (22)

A₀≅V_{c1} (23)

The voltage Vds becomes similar in shape to a terminal voltage Vnn of the first auxiliary winding Nn. The terminal voltage Vnn has been supplied to the control module CNT1. The control module CNT1 is set to detect the time (t14) when the terminal voltage Vnn becomes zero and to turn ON the field-effect transistor FET1 after a passage of a prescribed period of time from time t14. It is a feature of the quasi-resonant converter that based on this arrangement, a switching loss or radiation noise is reduced by turning ON the field-effect transistor FET1 at the time when the voltage Vds becomes lowest. Each of periods of time Δt from time t13 to time t14 and from time t14 to time t15 is ¼ of the LC resonance period T0, which is a known value represented by the following expression (24):

$$Δ t ≅ \frac{{T}_{0}}{4} ≅ \frac{π \sqrt{{L}_{p} \cdot {C}_{r 1}}}{2} \qquad ( 24 )$$

Thus, by turning ON the field-effect transistor FET1 after a period of time Δt from time t14, the field-effect transistor FET1 can be turned ON at a lowest point of the LC resonant voltage (time t15). In FIG. 2, the field-effect transistor FET1 is turned ON in a state where the voltage Vds decreases below zero and a body diode D1 of the field-effect transistor FET1 becomes conductive. Switching when the voltage Vds is roughly zero is generally referred to as zero volt switching (ZVS). By the zero volt switching, a switching loss or radiation noise can be greatly reduced at the time of turning-ON.

When the field-effect transistor FET1 is turned ON (time t15 and after), a drain current Id starts to flow again to the field-effect transistor FET1 via the primary winding Np of the transformer T1. In this case, negative pulse voltages are induced in the secondary winding Ns and the first auxiliary winding Nn. On the other hand, a positive pulse voltage is induced in the second auxiliary winding Nh. The negative pulse voltage Vnn1 induced in the first auxiliary winding Nn is generally represented by the following expression (25) using a voltage Vh:

$${V}_{nn 1} ≅ {V}_{h} \cdot \frac{{N}_{n}}{{N}_{p}} \qquad ( 25 )$$

The positive pulse voltage Vnhh induced in the second auxiliary winding Nh is generally represented by the following expression (26) using the voltage Vh:

$${V}_{nhh} ≅ {V}_{h} \cdot \frac{{N}_{h}}{{N}_{p}} \qquad ( 26 )$$

The positive pulse voltage Vnhh is rectified and smoothed by the diode D4 and the capacitor C5 to be supplied as a power supply voltage Vcc to the control module CNT1. Thereafter, the control module CNT1 continues its operation based on the power supply voltage Vcc. In this case, the power supply voltage Vcc is generally represented by the following expression (27), where Vfd4 denotes a forward voltage of the diode D4:

$${V}_{cc} ≅ {V}_{nhh} - {V}_{fd 4} ≅ {V}_{h} \cdot \frac{{N}_{h}}{{N}_{p}} - {V}_{fd 4} \qquad ( 27 )$$

Thereafter, the operation of the period of time from time t11 to time t15 is repeated.

FIG. 3 illustrates operation waveforms of the quasi-resonant converter in the power saving mode. In the power saving mode, when the output voltage decreases from Vout-h to Vout-l, the voltage Vc1 decreases as generally represented by the following expression (28):

$${V}_{c 1} ≅ ( {V}_{out - 1} + {V}_{fd 3} ) \cdot \frac{{N}_{p}}{{N}_{s}} \qquad ( 28 )$$

While the field-effect transistor FET1 is OFF (time t22 to time t23), a positive pulse voltage Vnnh induced in the first auxiliary winding Nn decreases as generally represented by the following expression (29):

$${V}_{nnh} ≅ ( {V}_{out - 1} + {V}_{fd 3} ) \cdot \frac{{N}_{n}}{{N}_{s}} \qquad ( 29 )$$

A negative pulse voltage Vnh1 induced in the second auxiliary winding Nh decreases as generally represented by the following expression (30):

$${V}_{nh 1} ≅ ( {V}_{out - 1} + {V}_{fd 3} ) \cdot \frac{{N}_{h}}{{N}_{s}} \qquad ( 30 )$$

On the other hand, while the field-effect transistor FET1 is ON (time t25 and after), a negative pulse voltage Vnn1 induced in the first auxiliary winding Nn is generally represented by the following expression (31) using the voltage Vh:

$${V}_{nn 1} ≅ {V}_{h} \cdot \frac{{N}_{n}}{{N}_{p}} \qquad ( 31 )$$

A positive pulse voltage Vnhh induced in the second auxiliary winding Nh is generally represented by the following expression (32) using the voltage Vh:

$${V}_{nhh} ≅ {V}_{h} \cdot \frac{{N}_{h}}{{N}_{p}} \qquad ( 32 )$$

Thus, a power supply voltage Vcc of the control module CNT1 is generally represented by the following expression (33):

$${V}_{cc} ≅ {V}_{nhh} - {V}_{fd 4} ≅ {V}_{h} \cdot \frac{{N}_{h}}{{N}_{p}} - {V}_{fd 4} \qquad ( 33 )$$

As apparent from the expression (33), the power supply voltage Vcc is not dependent on a value of the output voltage Vout-l. Thus, in the power saving mode, even when the output voltage is reduced, the power supply voltage Vcc of the control module CNT1 never decreases. There is placed no limit on a reduction amount of the output voltage different from the case discussed above in the description of the related art. As a result, in the power saving mode, the output voltage can be sufficiently reduced, and power consumption can be adequately reduced.

Next, a second exemplary embodiment of the present invention will be described.

In the configuration of the first exemplary embodiment illustrated in FIG. 1, the power supply voltage Vcc of the control module CNT1 is not dependent on the value of the output voltage Vout-l (expression (33) of the first exemplary embodiment). As apparent from the expression (33), the power supply voltage Vcc is approximately proportional to a rectifying voltage Vh of a commercial alternating power source. Thus, for example, when a trouble of a power transmission system causes a reduction in voltage of the commercial alternating power source, the power supply voltage Vcc decreases, disabling the control module CNT1 to continue its stable operation. The present exemplary embodiment enables, even when the voltage of the commercial alternating power source decreases, securing of a power supply voltage Vcc which permits a stable operation of the control module CNT1.

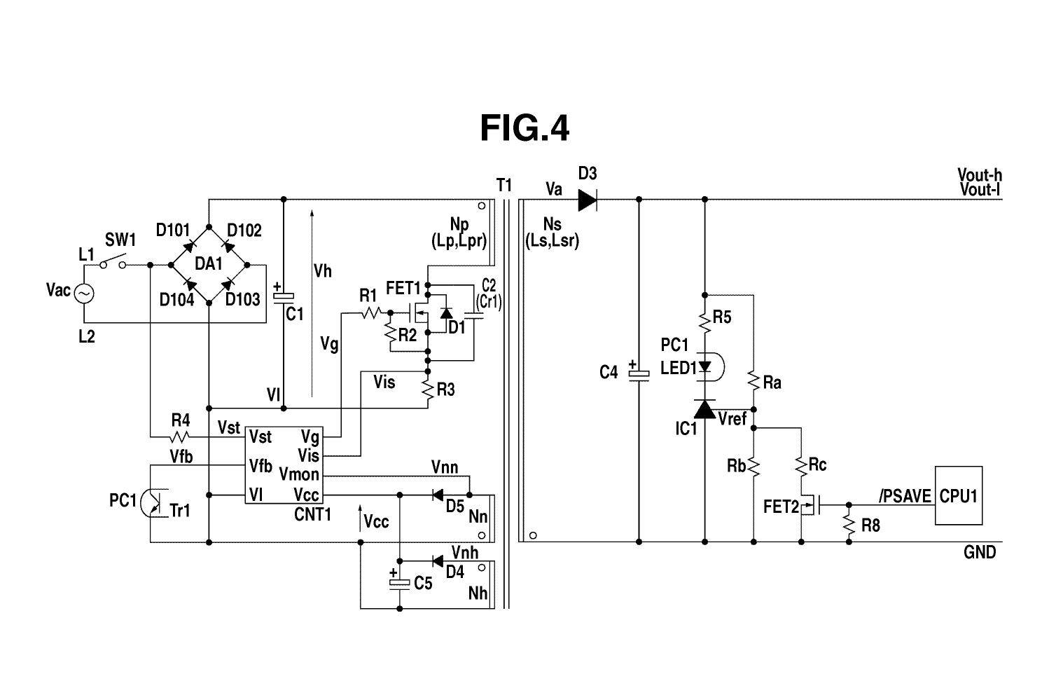

FIG. 4 illustrates a quasi-resonant converter according to the second exemplary embodiment of the present invention. The present exemplary embodiment has a feature that in addition to the components of the quasi-resonant converter of the first exemplary embodiment illustrated in FIG. 1, a diode D5 is provided between an auxiliary winding Nn and the control module CNT1, and a cathode terminal of the diode D5 is connected to a capacitor C5. Portions similar to those of the first exemplary embodiment are denoted by similar reference numerals, and description thereof is omitted.

In the configuration illustrated in FIG. 4, when a voltage of the commercial alternating power source is within a normal range, as described above in the first exemplary embodiment, a direct current voltage that is a power supply voltage Vcc of the control module CNT1 is obtained by rectifying and smoothing a positive pulse voltage of an auxiliary winding Nh by the diode D4 and the capacitor C5. In the present exemplary embodiment, the direct current voltage is set as a first direct current voltage.

When the voltage of the commercial alternating power source decreases below a value of the normal range, the first direct current voltage obtained by rectifying and smoothing the positive pulse voltage of the auxiliary winding Nh decreases. Thus, a second direct current voltage obtained by rectifying and smoothing a positive pulse voltage of the auxiliary winding Nn by the diode D5 and the capacitor C5 is supplied as a power supply voltage Vcc to the control module CNT1. More specifically, the higher one of the first direct current voltage based on the positive pulse voltage of the auxiliary winding Nh and the second direct current voltage based on the positive pulse voltage of the auxiliary winding Nn is set as a power supply voltage Vcc.

The positive pulse voltage Vnnh of the auxiliary winding Nn is represented by the following expression (34):

$${V}_{nnh} ≅ ( {V}_{out - h} + {V}_{fd 3} ) \cdot \frac{{N}_{n}}{{N}_{s}} \qquad ( 34 )$$

Thus, the power supply voltage Vcc is generally represented by the following expression (35), where Vfd5 denotes a forward voltage of the diode D5:

$${V}_{cc} ≅ {V}_{nhh} - {V}_{fd 5} ≅ ( {V}_{out - h} + {V}_{fd 3} ) \cdot \frac{{N}_{n}}{{N}_{s}} - {V}_{fd 5} \qquad ( 35 )$$

As apparent from the expression (35), the power supply voltage Vcc is not dependent on a value of a rectifying voltage Vh of the commercial alternating power source. Hence, a reduction in voltage of the commercial alternating power source never decreases the power supply voltage Vcc. The control module CNT1 can continue its stable operation.

According to the present exemplary embodiment, even when the voltage of the commercial alternating power source decreases, a power supply voltage Vcc that enables a stable operation of the control module CNT1 can be secured.

Next, a third exemplary embodiment of the present invention will be described.

In the configuration of the first exemplary embodiment illustrated in FIG. 1, as represented by the expression (33), the power supply voltage Vcc of the control module CNT1 is not dependent on the value of the output voltage Vout-l. As apparent from the expression (33), the power supply voltage Vcc is approximately proportional to the rectifying voltage Vh of the commercial alternating power source. Thus, for example, when a trouble of a power transmission system increases the voltage of the commercial alternating power source, the power supply voltage Vcc increases, exceeding a rated voltage of the control module CNT1. The present exemplary embodiment enables, even when the voltage of the commercial alternating power source increases, prevention of the power supply voltage Vcc supplied to the control module CNT1 from exceeding the rated voltage.

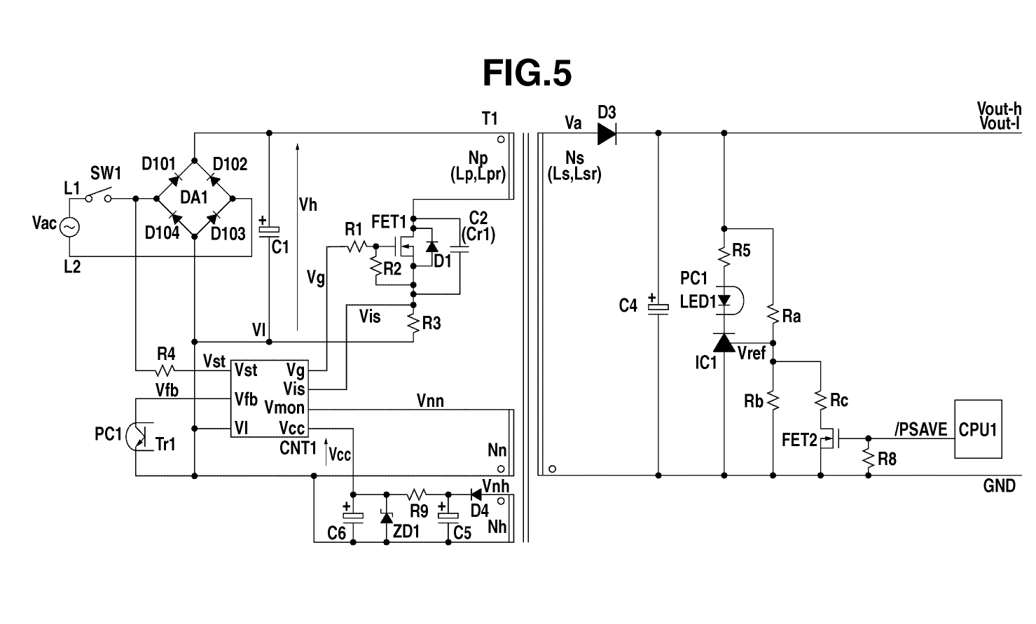

FIG. 5 illustrates a circuitry of a quasi-resonant converter of the present exemplary embodiment. The present exemplary embodiment has a feature that in addition to the components of the quasi-resonant converter of the first exemplary embodiment illustrated in FIG. 1, a constant voltage source including a resistor R9, a Zener diode ZD1, and a capacitor C6 is provided. A breakdown voltage of the Zener diode ZD1 is set roughly equal to or less than the rated voltage of the control module CNT1. Portions similar to those of the first exemplary embodiment are denoted by similar reference numerals, and description thereof is omitted.

In the configuration illustrated in FIG. 5, when the voltage of the commercial alternating power source is within a normal range, more specifically, when a direct current voltage generated by rectifying and smoothing a positive pulse voltage of an auxiliary winding Nh by a diode D4 and a capacitor C5 is within the rated range of the control module CNT1, the direct current voltage becomes a power supply voltage Vcc via the resistor R9 and the capacitor C6 to be supplied to the control module CNT1.

When the voltage of the commercial alternating power source exceeds the normal range, more specifically, when a direct current voltage generated by rectifying and smoothing the positive pulse voltage of the auxiliary winding Nh by the diode D4 and the capacitor C5 exceeds the rated range of the control module CNT1, the direct current voltage is clamped, by the resistor R9 and the Zener diode ZD1, into a direct current voltage within the rated range of the control module CNT1. The direct current voltage is supplied as a power supply voltage Vcc to the control module CNT1. More specifically, when the direct current voltage is large, the direct current voltage is transformed to be supplied as a power supply voltage Vcc to the control module CNT1.

As a result, even when the voltage of the commercial alternating power source exceeds the normal range, the power

What is claimed is:

1. A converter comprising:
a switching element configured to switch a voltage supplied via a primary winding of a transformer;
a control unit configured to control timing so as to turn ON the switching element based on a resonant voltage supplied to the switching element by a resonant operation between inductance of the primary winding and capacitance between a drain and a source of the switching element; and
a setting unit configured to set an output voltage,
wherein when the output voltage is set to a low voltage, the control unit turns ON the switching element according to a first pulse voltage induced in a first auxiliary winding different in winding direction from the primary winding, and operates based on a second direct current voltage by rectifying and smoothing a second pulse voltage induced in a second auxiliary winding similar in winding direction to the primary winding.

2. The converter according to claim 1, wherein the control unit operates based on a higher one of a first direct current voltage output by rectifying and smoothing the first pulse voltage and the second direct current voltage.

3. The converter according to claim 1, wherein the control unit operates based on a direct current voltage obtained by transforming the second direct current voltage.

4. A converter comprising:
a switching element configured to switch a first voltage supplied via a primary winding of a transformer;
a control portion configured to control an ON period of the switching element so as to control a second voltage induced in a secondary winding of the transformer,
wherein the control portion operates based on a first auxiliary voltage induced in a first auxiliary winding similar in winding direction to the primary winding.

5. The converter according to claim 4,
further comprising a second auxiliary winding,
wherein the second auxiliary winding has a similar winding direction as the secondary winding, and
wherein the control portion controls the switching element based on a second auxiliary voltage induced in the second auxiliary winding.

6. The converter according to claim 4,
further comprising a voltage setting portion configured to set the second voltage,
wherein when the voltage setting portion sets the second voltage to a low voltage, the first auxiliary voltage is maintained to a voltage that is larger than a predetermined value.

7. A power supply comprising:
a switching element configured to switch a voltage supplied via a primary winding of a transformer;
a control portion configured to control an ON period of the switching element so as to control a second voltage induced in a secondary winding of the transformer,
a first auxiliary winding different in winding direction to the primary winding;
a second auxiliary winding similar in winding direction to the primary winding,
wherein the control portion operates based on the second voltage induced in the secondary winding similar in winding direction to the primary winding.

8. The power supply according to claim 7,
wherein the control portion controls the switching element based on a first auxiliary voltage induced in the first auxiliary winding.

9. The power supply according to claim 7, further comprising a voltage setting portion configured to set the second voltage,
wherein when the voltage setting portion sets the second voltage to a low voltage, a second auxiliary voltage is maintained to a voltage that is larger than a predetermined value.
